(19) United States
(12) Patent Application Publication
(10) Pub. No.: US 2025/0146813 A1
(43) Pub. Date: May 8, 2025

(54) AN ULTRASONIC DISTANCE SENSOR-BASED, FULLY AUTOMATIC, CONTACTLESS, AND PORTABLE SYSTEM FOR ESTIMATION OF LIVE AND CARCASS WEIGHTS OF CATTLE

(71) Applicant: ATATÜRK ÜNIVERSITESI FIKRI MÜLKIYET HAKLARI KOORDINATÖRLÜGÜ DÖNER SERMAYE ISLETMESI, Erzurum (TR)

(72) Inventors: Mevsen PIRIMOGLU DAL, Erzurum (TR); Deniz DAL, Erzurum (TR)

(21) Appl. No.: 18/837,832

(22) PCT Filed: Nov. 23, 2023
(86) PCT No.: PCT/TR2023/051380

§ 371 Date: Aug. 12, 2024

(30) Foreign Application Priority Data
Dec. 13, 2022 (TR) 2022/019210

(51) Int. Cl. G01B 21/04; G01B 17/00; G01G 9/00; G01G 17/08

(52) U.S. Cl. CPC G01B 21/04; G01B 17/00; G01G 9/00; G01G 17/08

(57) ABSTRACT

Disclosed is a digital system, featuring a fully-automatic, contactless, and portable device reliant on ultrasonic distance sensors, designed to replace the conventional, manual, and contact-based method, wherein cattle's chest circumference is measured in centimeters via tape measure and converted into estimated live weight using the given table.

### FIELD OF THE INVENTION

The present invention relates to an innovative digital system, featuring a fully automatic, contactless, and portable device reliant on ultrasonic distance sensors, designed to replace the conventional, manual, and contact-based method, wherein cattle's chest circumference is measured in centimeters via tape measure and converted into estimated live weight using the given table.

### STATE OF THE ART

In situations where there is no access to a weighbridge or other type of weighing equipment (e.g., in villages, fattening farms or sacrificial markets), the live weight of cattle should be estimated with a minimum margin of error. There are many benefits of live weight estimation and a few of them are listed below:
i. It is important to determine the live weight of fattening animals at least once a month in order to determine whether feeding is done correctly and to identify animals that do not keep fattening.
ii. There is a relationship between live weight and carcass weight determined by a quantity called yield. If the live weight of cattle is known or estimated, it is possible to determine the carcass weight based on dressing percentage. For example, the affordable price per kilogram paid for the carcass meat of a purchased cattle is the most important factor taken into account when shopping in sacrifice or live animal markets.

One of the methods used to determine the estimated live weight is to measure the chest circumference of cattle with a tape measure. This method, which requires the animal to be on all fours and with its head in a straight position during the measurement, is currently operated by following the steps below:
i. The person who will measure the chest circumference approaches the animal as shown in FIG. 3, locates the beginning of the tape measure at the end of the animal's forelegs, moves it around the chest and finally connects the current position of the tape measure with the starting point.
ii. The live weight is then estimated by using the chest circumference measured in centimeters and the table prepared by the Ministry of Agriculture and Forestry and given in FIG. 4. For example, if the chest circumference of the animal is measured as 147 cm, according to this table, the estimated live weight is 253 kg for a normal animal and 273 kg for a fattened animal.

There are some problems with the scenario detailed above:
i. First of all, the whole process is manual.
ii. Measuring the animal's chest circumference requires close contact with the animal, which can lead to serious risks and even injury if the animal's response is unknown. Moreover, this intervention is considered a source of stress for both the animal and the measurer.
iii. It is necessary to do arithmetic for the transition from live weight to carcass weight. After the live weight is determined, 8% toughness wastage is deducted from this weight. An estimation is then made by calculating the magnitude of this new weight between 50% and 60% of the known yield of the cattle breed.

There are other methods in the literature for estimating live weight of cattle from chest circumference, but these methods are often camera-dependent, image processing-based, and not portable. For this purpose, images are taken from the right, left and front of the animal, in other words from different angles with fixed-position cameras, and these images are processed with special algorithms to calculate the chest circumference. This value is then converted into a live weight estimate. Such solutions are therefore both expensive and relatively cumbersome to use. This is because cameras are used to capture images and computers are used to process them.

As a result, due to the abovementioned disadvantages and the insufficiency of the current solutions regarding the subject matter, a development is required to be made in the relevant technical field.

### BRIEF DESCRIPTION OF THE INVENTION

The present invention aims to provide a structure having different technical features which brings a new development in this field different from the embodiments used in the state of the art.

The main aim of the present invention is to provide a fully automatic, contactless, ultrasonic distance sensor-based, portable, innovative, and digital live weight estimation system that eliminates the disadvantages detailed above.

Another aim of the present invention is to develop a system to estimate live weight as well as carcass weight by means of a low-cost and palm-sized embedded system box.

The present invention is an innovative digital system for estimating live and carcass weight from the length of the chest circumference of cattle using the table method, characterized in that; it utilizes a palm-sized and portable embedded system box with the following placed therein;
i. A microcontroller, which comprises the table containing estimated live weight data corresponding to the length of the chest circumference to be measured, reads data from ultrasonic distance sensors positioned on the horizontal and vertical axes, determines the starting and end point of the animal's chest circumference to be measured, converts horizontal and vertical distances measured by ultrasonic distance sensors into point coordinates in two-dimensional space, calculates the distance between two consecutive points, calculates the animal's chest circumference by adding up all the distances it calculates, finds the estimated live weight corresponding to the chest circumference calculated in centimeters from the table embedded therein, converts the estimated live weight into estimated carcass weight and delivers all this information to the LCD display as output,
ii. An LCD display that reflects the estimated live and carcass weight information detected by the microcontroller to the user,
iii. A laser pointer used to mark the area where the animal's chest circumference is to be measured and thus avoid inaccurate measurements,
iv. An ultrasonic distance sensor measuring distance in the horizontal axis,
v. An ultrasonic distance sensor measuring distance in the vertical axis.

The structural and characteristic features of the present invention will be understood clearly by the following drawings and the detailed description made with reference to these drawings and therefore the evaluation shall be made by taking these figures and the detailed description into consideration.

### FIGURES CLARIFYING THE INVENTION

FIG. 1 is a representative illustration of the embedded system box with its components for measuring chest circumference of cattle.

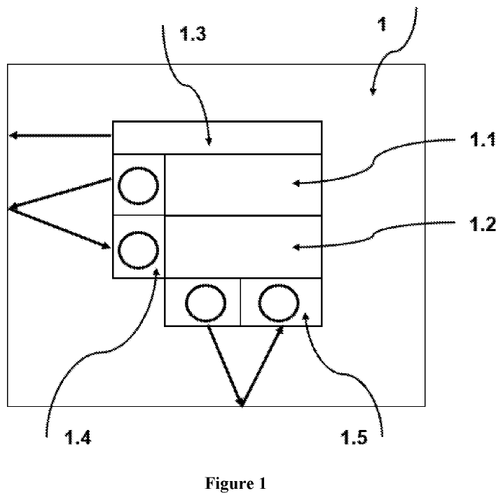

FIG. 2 is an illustration of the calculation of the chest circumference of cattle with distances measured on the horizontal and vertical axes.

FIG. 3 is an image showing the chest circumference of the cattle to be measured.

FIG. 4 is an illustration of the table containing the estimated live weight values corresponding to the chest circumference of the cattle measured in centimeters.

The figures are not required to be scaled and the details which are not necessary for understanding the present invention may be neglected. Moreover, the elements that are at least substantially identical or have at least substantially identical functions are shown by the same number.

### DESCRIPTION OF THE FIGURE REFERENCES

1. Embedded system box,
1.1. Microcontroller,
1.2. LCD display,
1.3. Laser pointer positioned on the horizontal axis of the embedded system box,
1.4. Ultrasonic distance sensor positioned on the horizontal axis of the embedded system box,
1.5. Ultrasonic distance sensor positioned on the vertical axis of the embedded system box,
2.1. Distances measured with the ultrasonic distance sensor positioned on the horizontal axis of the embedded system box,
2.2. Distances measured with the ultrasonic distance sensor positioned on the vertical axis of the embedded system box,
2.3. Half of the cattle's chest
2.4. The distance between two consecutive points in two-dimensional space,
3.1. The region where the chest circumference of the cattle will be measured,
3.2. The starting point of the region where the chest circumference of the cattle will be measured,
3.3. The end point of the region where the chest circumference of the cattle will be measured.

### Detailed Description of the Invention

In this detailed description, the preferred embodiments of the invention are described only for clarifying the subject matter in a manner such that no limiting effect is introduced.

The invention relates to an innovative system that digitizes the existing manual and contact-based method of measuring the chest circumference of cattle using a tape measure and converting the measurement values obtained in centimeters into an estimated live weight using a table, with an ultrasonic distance sensor-based, fully automatic, contactless, and portable device.

The embedded system box (1) used in the inventive system is a palm-sized and portable device. Said box (1) comprises a microcontroller (1.1), an LCD display (1.2), a laser pointer (1.3), an ultrasonic distance sensor positioned on the horizontal axis (1.4), and an ultrasonic distance sensor positioned on the vertical axis (1.5). Ultrasonic distance sensors help to find the distance of an object using sound waves called sonar (sound navigation and ranging). Within the scope of the invention, the chest circumference of the cattle can be determined by measuring several distances using two such sensors.

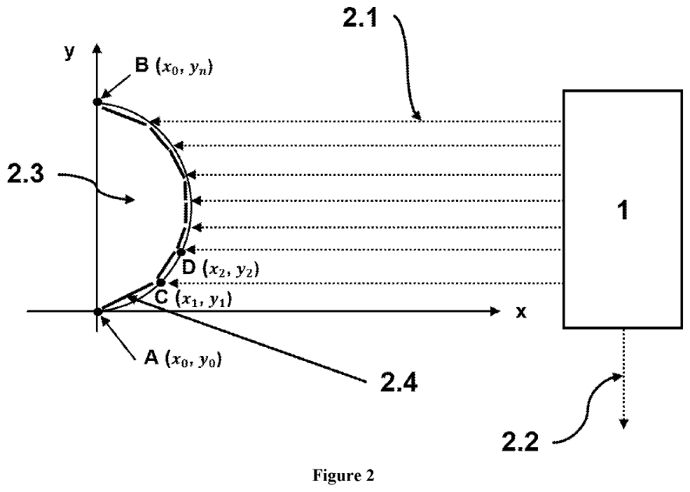

Of the ultrasonic distance sensors positioned on the horizontal and vertical axes of the embedded system box (1), the horizontal one (1.4) measures the distance between the box (1) and the animal, and the vertical one (1.5) measures the ground clearance of the box (1). The laser pointer (1.3) positioned on the horizontal axis of the box moves at the animal's chest line (3.1) when the box (1) is moved up and down. This verifies that distance measurements are taken around the chest. As seen in FIG. 2, different points in two-dimensional space are obtained with the distances measured on the horizontal and vertical axes. The distance between each successive point is then calculated (2.4) and finally all distances are summed up to get the chest circumference automatically.

The processing steps performed with the inventive system are generally as follows:

For the measurement, the person standing at a certain distance from the animal (e.g., 2 meters) moves the embedded system box (1) slowly upwards from the ground.

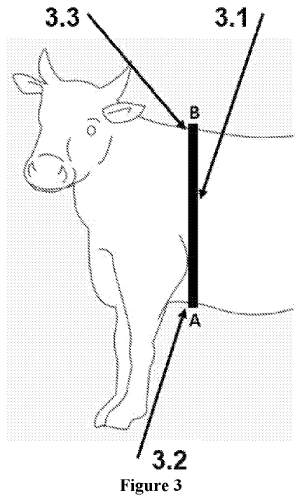

As shown in FIG. 3, when the height of the box from the ground is aligned with point A, there is an anomalous drop in the value measured by the horizontal distance sensor (1.4), which allows the first point on the chest (3.2) to be detected.

The values measured by the distance sensors at this point are considered as the origin of the coordinate system used by the method. These values are called x₀ (the distance of the horizontally positioned distance sensor to point A) and y₀ (the height of the vertically positioned distance sensor above the ground, i.e., the height of point A above the ground). Said A point (3.2) is also the origin of the two-dimensional coordinate system given by FIG. 2.

After this step, the box (1) is moved a little higher each time and this process is repeated until the laser pointer (1.3) points to point B. Point B is the last point of the chest to be measured (3.3). Meanwhile, each horizontal and vertical distance measured is subtracted from x₀ and y₀, respectively, and converted into a point coordinate in two-dimensional space.

This process is terminated when point B (3.3) is reached. Once point B (3.3) is passed, there will be no obstacle in front of the horizontal distance sensor and the measured distance will change radically, thus it will be possible to detect point B (3.3).

For example, the x₁ and y₁ coordinates of point C in FIG. 2 are obtained by subtracting the distances measured by the distance sensors (1.4 and 1.5) on the horizontal and vertical axes from x₀ and y₀, respectively. In this way, point A (3.2) is taken as a reference and used to determine how far point C is from point A (3.2) horizontally and vertically.

As the laser pointer (1.3) moves between point A (3.2) and point B (3.3) in the chest line (3.1), a record of each detected coordinate is stored on the microcontroller. As can be seen in FIG. 2, in the last step, the length between both of these coordinates (2.4) consecutively is calculated with the distance formula \sqrt{(x₀-x₁)²+(y₀-y₁)²} and these lengths are summed to obtain the circumference of one half of the chest (2.3). (By summing the length of the small lines (2.4) in FIG. 2, which indicate the distances between consecutive coordinates.)

Assuming that the chest is symmetrical, the length of the entire chest circumference is calculated by multiplying the circumference of one half by 2 or by performing a similar procedure on the other half and summing the values obtained for both halves.

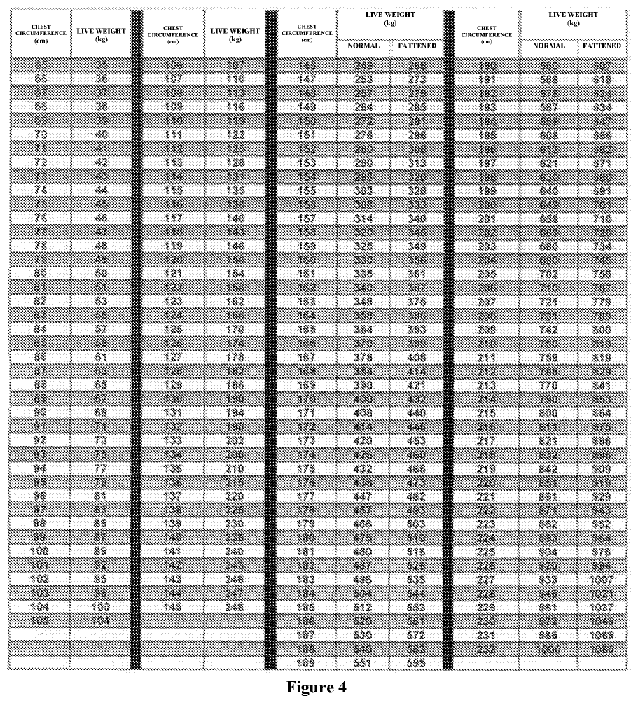

The table given in FIG. 4 is embedded in the microcontroller (1.1). In this step, the live weight corresponding to the chest circumference calculated by the microcontroller (1.1) is automatically extracted from the table and the data corresponding to both normal and fattened cattle are reflected on the LCD display (1.2) on the box (1).

The new weight to be used as the basis for carcass weight is calculated by deducting 8% toughness wastage from this live weight.

The equivalents of this weight for yield values between 50% and 60% are calculated and information about possible carcass weights is displayed to the user on the LCD display (1.2).

1. A system for estimating live and carcass weight from the length of the chest circumference of cattle by the table method, comprising an embedded system box.

2. A method according to claim 1, said embedded system box comprising:
a microcontroller, which comprises the table containing estimated live weight data corresponding to the length of the chest circumference to be measured, reads data from ultrasonic distance sensors positioned on the horizontal and vertical axes, determines the starting and end point of the animal's chest circumference to be measured, converts horizontal and vertical distances measured by ultrasonic distance sensors into point coordinates in two-dimensional space, calculates the distance between two consecutive points, calculates the animal's chest circumference by adding up all the distances it calculates, finds the estimated live weight corresponding to the chest circumference calculated in centimeters from the table embedded therein, converts the estimated live weight into estimated carcass weight and delivers all this information to the LCD display as output,
an LCD display that reflects the estimated live and carcass weight information detected by the microcontroller to the user,
a laser pointer used to mark the area where the animal's chest circumference is to be measured and thus avoid inaccurate measurements,
an ultrasonic distance sensor measuring distance in the horizontal axis, and
an ultrasonic distance sensor measuring distance in the vertical axis.

3. A method according to claim 2, wherein said ultrasonic distance sensor, positioned on the horizontal axis, measures the distance of the box to the animal.

4. A method according to claim 2, wherein said ultrasonic distance sensor, positioned on the vertical axis, measures the height of the box above the ground.

5. A method according to claim 2, wherein it is based on the principle that a person standing at a certain distance from the animal for measurement moves the embedded system box in his/her hand slowly upwards from the ground aligned with the chest region.

6. A method according to claim 5, wherein it can operate independently of the distance at which the measurement is to be made.

7. A method according to claim 1, wherein it calculates a new weight based on carcass weight by deducting 8% toughness wastage from the estimated live weight calculated by the aforementioned system.

8. A method according to claim 7, wherein said system calculates provisions for yield values between 50% and 60% of the estimated live weight minus 8% toughness wastage and thus provides the user with information on possible carcass weights on the LCD display.

9. A method according to claim 2, wherein the microcontroller detects the starting point of the animal's chest circumference to be measured and uses this point as the origin of the two-dimensional coordinate system.

10. A method according to claim 9, wherein it transforms each point coordinate between the starting point and the last point of the chest circumference of the animal to be measured into a new pair of values with reference to the origin.

11. A method according to claim 2, wherein said embedded system box is low-cost, palm-sized, and portable.

12. A method according to claim 1, wherein said system is based on ultrasonic distance sensors.

13. A method according to claim 1, wherein said system is fully automatic.

14. A method according to claim 1, wherein said system is contactless.
